(19) United States
(12) Patent Application Publication
(10) Pub. No.: US 2016/0288396 A1
(43) Pub. Date: Oct. 6, 2016

(54) MELT FILTER COMPRISING A DRIVE DEVICE FOR A ROTATABLE DISK SCREEN

(71) Applicant: GNEUSS GMBH, Bad Oeynhausen (DE)

(72) Inventors: Detlef GNEUSS, Oeynhausen (DE); Stephan GNEUSS, Oeynhausen (DE); Daniel GNEUSS, Charlotte, NC (US)

(21) Appl. No.: 14/777,567

(22) PCT Filed: May 12, 2014
(86) PCT No.: PCT/EP2014/059631

§ 371 Date: Sep. 16, 2015

(30) Foreign Application Priority Data
May 16, 2013 (DE) 102013209137.0

(51) Int. Cl. B29C 47/68; B01D 33/48; B01D 33/15; B29C 47/08; B29C 47/92

(52) U.S. Cl. CPC B29C 47/683; B29C 47/0801; B29C 47/0815; B29C 47/92; B01D 33/15; B01D 33/48; B29C 2947/92876; B29K 2105/0067

(57) ABSTRACT

The invention relates to a melt filter (1) comprising: at least one rotatable disk screen (2) which holds a screen insert (3), at least one screen insert (3) being displaceable inside the melt filter (1) by means of a drive device for the rotatable disk screen (2) in such a way that said screen insert (3) lies opposite a melt feed opening (6); and comprising a piston (13) for backflushing and/or pre-flooding. The object of the invention is to develop a melt filter such that the drive device for backflushing and/or pre-flooding is simplified. To achieve this object, the piston (13) is operatively connected to the drive device and can be driven by said drive device in order to carry out the backflushing and/or pre-flooding operation.

The invention relates to a melt filter, in particular for filtering plastic melts in or in connection with an extruder, comprising a drive for the stepwise rotation of a sieve disk that holds at least one screen insert at least one of which is movable into a melt stream with the screen insert aligned with a melt-feed opening, and comprising a piston/cylinder unit for backflushing and/or prefilling.

A device for providing a melt known from DE 103 26 487 [U.S. Pat. No. 7,411,163] describes a melt filter having a melt purification station in which a melt shot piston/cylinder unit enables the pressing of purified melt in the direction opposite the melt flow direction through slot-like portions of the filter housing.

EP 554 237 discloses a filter apparatus for contaminated fluids, in which a screen insert on a screen support body is displaceable between a filtering position, a backflushing position and an insert-changing position. It is considered advantageous that the screen support body is not rotatable, but rather is displaceable axially back and forth so that the screen insert must only be displaced in the insert-changing position for an actual changing. This filter apparatus comprises a storage space from which already purified melt is drawn by a piston/cylinder unit for use on the one hand to maintain the pressure at the output of the filter apparatus, as well as for backflushing in the filter apparatus. This piston/cylinder unit is preferably driven by its own drive that is independent of the movement of the screen support body.

WO 92/16351 [U.S. Pat. No. 5,417,856] also discloses a filter apparatus for fluids to be purified that comprises an axially displaceable screen support body forming a storage space that is filled with purified melt via a piston/cylinder unit and that can be used for the purpose of backflushing screen inserts. The piston/cylinder unit comprises a drive that is independent of the drive for the screen support body. Alternatively, the piston/cylinder unit is integrated in the storage space of the axially displaceable screen support such that the piston/cylinder unit is held via a special attachment during movement of the screen support body, so that the storage space can be filled or emptied by movement of the screen support body. However, a direct connection is between the piston/cylinder unit and the drive for the screen support body does not exist.

DE 35 22 050 describes a melt filter comprising a rotating sieve disk for cleaning plastic melts, in particular discharged from extruders, where a sieve disk is rotatable in a housing with a plurality of screen segments in a circular array. The screen disk is rotated by a pawl drive so that the filter elements can be successively aligned with a melt passage.

The object of the invention is to develop a melt filter of the above-described type such that the drive for backflushing and/or prefilling is simplified.

The object is attained according to the invention for a melt filter of the above-described type through the features of patent claim 1. Advantageous embodiments are specified in the dependent claims.

The object is achieved according to the invention in that the piston/cylinder unit is connected to the drive and can be driven by the drive in order to carry out the backflushing and/or prefilling operation. adfasdfas

The drive is thereby able to simultaneously rotate the sieve disk and to effect the backflushing and/or prefilling, so that a second drive for the piston/cylinder unit may be spared. Unlike an axially displaceable screen insert, in which the screen insert may only be arranged either in the melt passage or in the backflushing passage, and in which protective measures must be taken in particular with regard to an excessively high rise in pressure in the backflushing piston/cylinder unit, through the use of a sieve disk, screen inserts that can be flowed through at the same time are simultaneously arranged both in the melt passage and in the purification station, so that no additional protective measures are required.

It is recommended that the drive comprise a pawl drive with a pawl that engages in a gear ring of the sieve disk, or a freewheel driven via a lever that acts on a gear ring of the sieve disk.

In both drives, a translational movement is converted into a rotational movement, which is needed for driving the sieve disk. The translational component of the drive is used simultaneously for driving of the piston/cylinder unit.

It has been found advantageous that between the drive and the piston/cylinder unit, a coupling is provided, by means of which the piston/cylinder unit is coupled with the drive for backflushing and/or prefilling.

The coupling between the drive and the piston/cylinder unit is thereby flexible.

If rinsing need not occur during each revolution or cycling, it is advantageous if the piston/cylinder unit for backflushing and/or prefilling can be selectively locked or decoupled via the coupling.

It has proven advantageous that a controller is provided, via which the coupling can be programmed or adjusted in its mode of action of the connection, so that the piston/cylinder unit can be adjustably coupled with the drive variably between a fixed and loose coupling, wherein the coupling in general but also the reciprocation, amount and/or degree of filling of the piston/cylinder unit can be adjusted.

According to the invention, the piston/cylinder unit can be arranged in the outlet block or inlet block.

Advantageously, the drive means comprises a double-acting piston/cylinder unit.

The invention will be described in further detail below with reference to illustrated embodiments shown in the drawings.

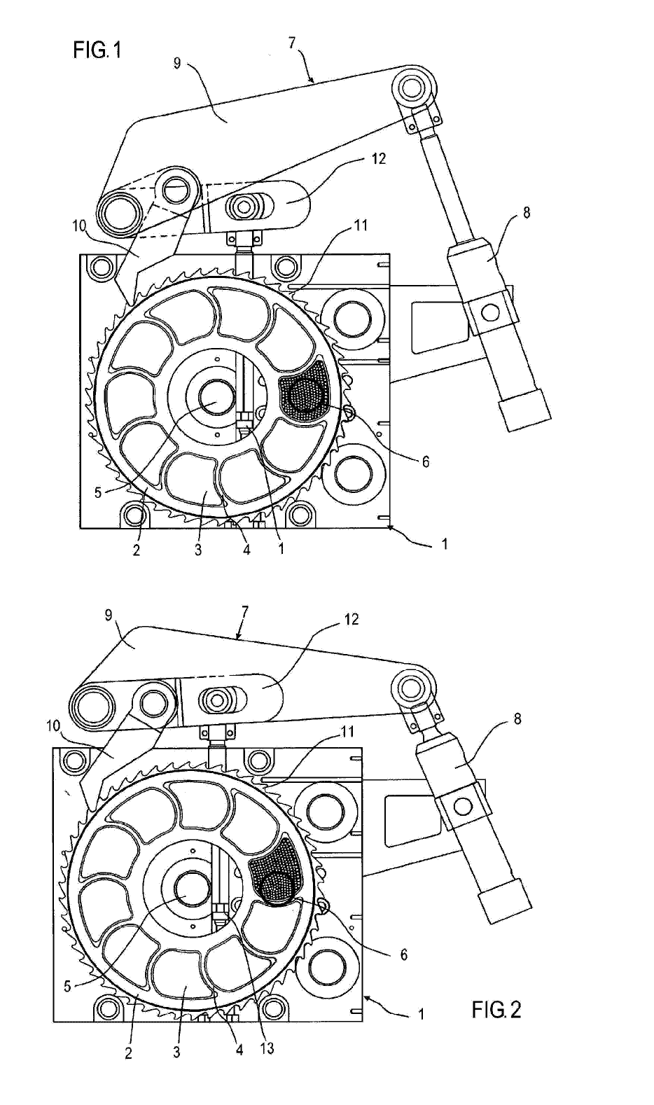

FIG. 1 is a top view of a melt filter according to the invention having a sieve disk with interchangeable screen inserts and a shot piston/cylinder unit for backflushing or prefilling in a first operating position,

FIG. 2 is a top view of the inventive melt filter of FIG. 1 in a second operating position,

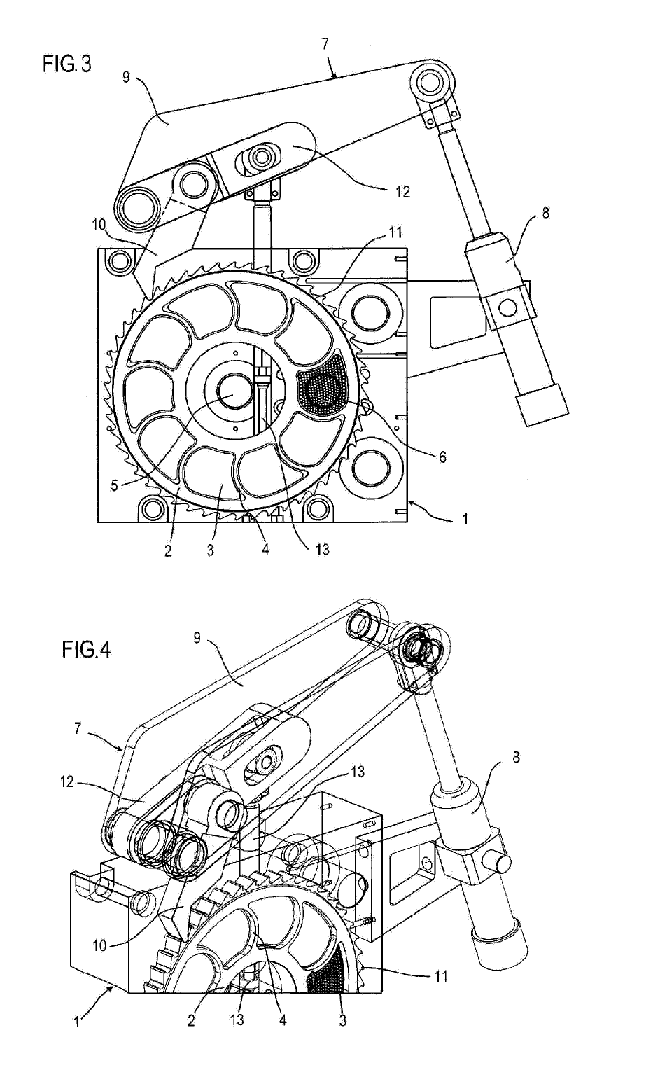

FIG. 3 is a top view of the inventive melt filter of FIG. 1 in a third operating position,

FIG. 4 is a perspective view of the drive of the inventive melt filter according to FIG. 3,

FIG. 5 is a view of a melt filter according to the invention with a drive in simplified construction, and

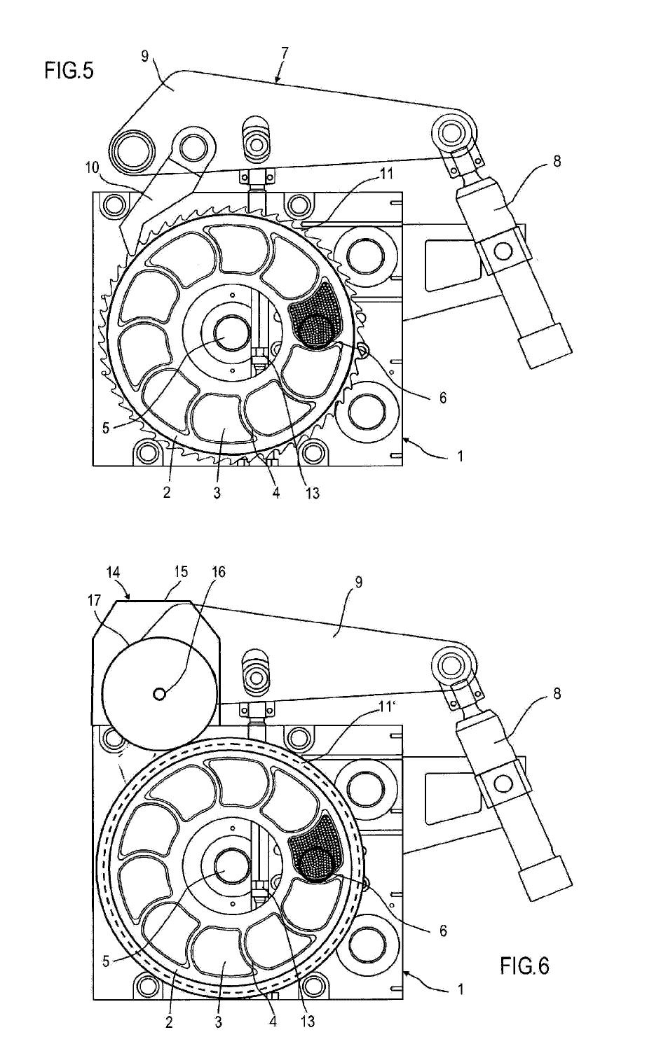

FIG. 6 is a view of a melt filter according to the invention with a freewheel drive.

In FIG. 1, a melt-filter housing 1 is shown with a circular sieve disk 2 in an illustrated embodiment in which a plurality of optionally interchangeable screen inserts 3 are used in an annular array and separated from one another by spoke webs 4. Typically, approximately ten to fourteen screen inserts 3 are provided in the sieve disk 2. The sieve disk 2 acts with its interchangeable screen inserts 3 as a melt filter and can be brought into a filtering position and a purifying and/or prefilling position by rotation about its axis 5.

The filter housing 1 consists of two plates of which only one is shown for the sake of clarity. The screen inserts 3 located in the filtering position are aligned with a melt-feed opening 6 of one housing plate that acts upon these areas with melt to be filtered, and that can extend over a plurality of screen inserts 3. The melt-feed opening 6 is supplied here by a melt passage (not shown).

The sieve disk 2 may be rotated about its axis 5 by a drive such that fresh screen inserts 3 are always in front of the melt-feed opening 6 and filter the melt stream. The screen inserts 3 that are partially clogged in the filtering position may be detected by a pressure increase upstream of the screen inserts 3 of the filter housing 1. Due to rotation, however, the available free screen surface always remains constant.

A pawl drive 7 rotates the sieve disk 2 about the central axis 5, with a double-acting piston/cylinder unit 8 of the pawl drive acting via a drive lever 9 a pawl 10 that engages in teeth of a gear ring 11 formed on the outer periphery of the sieve disk 2 and that rotates synchronously with the sieve disk 2.

A piston/cylinder unit 13, here a shot piston/cylinder unit for backflushing and/or prefilling, acts together with the is drive lever 9 of the pawl drive 7 via a coupling 12 for connecting or locking. Here, the coupling 12 may be engaged to be coupled with the drive lever 9 in phases, or may also be decoupled over one or more phases or even full revolutions. In the decoupled position, the drive here only actuates the sieve disk 2 with the screen inserts 3, so that a new screen insert 3 is always aligned with the melt-feed opening 6, however a backflushing or prefilling does not take place. In the coupled position of the drive lever 9 with the piston/cylinder unit 13 via the coupling 12, however, there is also a backflushing or prefilling of the screen insert 3 upstream in the rotation sieve-disk rotation direction of the corresponding opening before the screen insert is rotated into the filtering position aligned with the melt-feed opening 6.

In the illustration according to FIG. 1, the double-acting piston/cylinder unit 8 has lifted the drive lever 9 and preloaded the pawl 10. The piston/cylinder unit 13 remains in the resting position during upward movement of the drive lever 9, since the piston/cylinder unit 13 has been decoupled via the coupling 12.

The coupling 12, here a locking lever, may be coupled with the drive lever 9, for example, by an electromechanical or hydraulic latch. This may occur as the result of predetermined settings or programming that set, for example, the reciprocation, the amount and/or the degree of filling of the piston/cylinder unit 13.

In FIG. 2, the filter housing 1 according to FIG. 1 is now represented in a second operating position. For this purpose, the drive lever 9 has been lowered by the double-acting piston/cylinder unit 8 and the pawl 10 has further rotated the sieve disk 2 with the screen inserts 3 via the gear ring 11. During this movement of the double-acting piston/cylinder unit 8 and the drive lever 9, the piston/cylinder unit 13 and the locking lever remain in their positions according to FIG. 1, as the locking lever is not connected with the drive lever 9 via the coupling 12.

FIG. 3 shows the filter housing 1 according to FIG. 1 that is now located in a third operating position. For this purpose, the drive lever 9 has been raised by the double-acting piston/cylinder unit 8, and the pawl 10 has been shifted to the next tooth of the gear ring 11. The sieve disk 2 remains stationary. The piston/cylinder unit 13 is coupled via the coupling 12 with the drive lever 9, so that it is raised and brought into readiness for backflushing or prefilling.

The next actuation of the double-acting piston/cylinder unit 8 shifts the drive lever 9 into its lower position, and the pawl 10 further rotationally indexes the sieve disk 2 with the screen inserts 3. At the same time, due to coupling of the drive lever 9 with the piston/cylinder unit 13 via the coupling 12, the drive acts on the piston/cylinder unit 13, so that by actuation thereof the backflushing or prefilling is performed. After this process step, the mechanism is returned to the position according to FIG. 2. The piston/cylinder unit 13 may now either remain coupled, so that it may be repeatedly actuated and a plurality of backflushing or prefilling processes are performed. However, it may also be decoupled again, so that during continued advance of the sieve disk 2, the purification process or prefilling no longer repeats for the time being.

In FIG. 4, the drive of the filter housing 1 is shown in the third operating position according to FIG. 3 in a perspective partially transparent view. The locking or coupling of the drive lever 9 via the coupling 12 with the piston/cylinder unit 13 may now occur such that, for example, an unillustrated locking pin may be brought into the locking position from the outside by an unillustrated electromechanical device in an operating position according to FIG. 2, and may lie in different positions that, for instance, change the reciprocation stroke of the piston/cylinder unit 13. If the next time, the locking means again takes up this position, the electromechanical device, for example a solenoid, may again bring the locking pin back to its unlocked position.

FIG. 5 shows a simplified representation of a drive for the piston/cylinder unit 13. Here, the piston/cylinder unit 13 is connected directly to the drive lever 9 of the pawl drive 7. The interposed coupling 12 according to FIGS. 1 to 4 is omitted. Nevertheless, the path of the piston/cylinder unit and/or the filling stroke thereof can be influenced. For this purpose, a slot is provided in the drive lever 9. The connection of the piston/cylinder unit 13 guided therein may be fixed in different positions in the slot via an unillustrated control device.

FIG. 6 shows a drive, in which instead of a pawl drive, a freewheel 14 or freewheel drive is provided. The freewheel 14 is in a housing 15 secured to the filter housing 1. The drive lever 9 acts on its central drive shaft 16. An outer periphery 17 of the freewheel 14 carries an external gear ring and is rotated via clamping or locking elements, not shown. The outer ring 17 meshes with a gear ring 11′ of the sieve disk 2.

Here too, the piston/cylinder unit 13 is coupled with the drive lever 9 for the backflushing and/or prefilling process, as is already apparent in FIG. 5.

In the prefilling position, the sieve disk 2 is held between the parallel housing plates within a melt prefilling passage, and a prefilling opening for supplying the screen insert 3 of the sieve disk 2 is provided in the direction of flow of the melt prefilling stream. Rotation of the sieve disk 2 about the central axis 5, moves the screen inserts 3 successively into the path covered by the prefilling opening and subsequently into alignment with the melt-feed opening 6.

The present invention relates to a piston/cylinder unit drive, in which the piston/cylinder unit 13 for backflushing and/or prefilling is coupled with the drive of the sieve disk 2. In this case, the piston/cylinder unit drive is designed such that the piston/cylinder unit 13 can be decoupled, so that backflushing or prefilling need not occur during each revolution or cycle. The degree of filling of the piston/cylinder unit 13 may also be adjusted. The piston/cylinder unit 13 can be mounted in an outlet block or inlet block.

List of reference characters

| | |
|---|---|
| 1 | filter housing |
| 2 | sieve disk |
| 3 | screen inserts |
| 4 | spoke webs |
| 5 | axis |
| 6 | melt-feed opening |
| 7 | pawl drive |
| 8 | double-acting piston/cylinder unit |
| 9 | drive lever |
| 10 | pawl |
| 11 | gear ring |
| 12 | coupling |
| 13 | piston/cylinder unit |
| 14 | freewheel |
| 15 | housing |
| 16 | drive shaft |
| 17 | outer ring |

1. A melt filter for filtering plastic melts in or for connection with an extruder, comprising:
a rotatable sieve disk;
a housing surrounding the sieve disk and formed offset from an axis thereof with a melt-feed opening;
a drive for the stepwise rotation of the sieve disk;
a plurality of screen inserts held in the disk in an annular array surrounding a rotation axis of the disk, at least one of the screen inserts within the filter housing being axially traversed by a melt stream when the one screen insert is aligned with the melt-feed opening;
a piston/cylinder unit shiftable for backflushing or prefilling and connected with the drive so as to be drivable thereby for a backflushing and/or prefilling operation.

2. The melt filter according to claim 1, wherein the drive is a pawl drive having a pawl that engages in a gear ring of the sieve disk or a freewheel acting upon an outer periphery of the sieve disk.

3. The melt filter according to claim 1, further comprising:
a coupling between the drive and the piston/cylinder unit that can couple the piston/cylinder unit with the drive for backflushing or prefilling.

4. The melt filter according to claim 3, wherein the piston/cylinder unit for backflushing or prefilling can be selectively locked or uncoupled via the coupling.

5. The melt filter variable according to claim 3, further comprising:
a controller programmable to set a mode of action of the coupling so that the piston/cylinder unit can be coupled with and decoupled from the drive.

6. The melt filter according to claim 3, wherein a reciprocation stroke of the piston/cylinder unit can be adjusted.

7. The melt filter according to claim 3, wherein the amount or the degree of filling of the piston/cylinder unit can be adjusted.

8. The melt filter according to claim 1, wherein the piston/cylinder unit is in an outlet or inlet block.

9. The melt filter according to claim 1, wherein the drive comprises a double-acting piston/cylinder unit.

10. A melt filter for cleaning a plastic melt in or issuing from an extruder, the filter comprising:
a wheel rotatable about an axis and having an outer rim and a plurality of spokes forming an annular array of axially open spaces;
a pair of housing plates axially sandwiching and completely covering the wheel and forming offset from the axis a melt passage extending axially through the wheel at the spaces, whereby a melt stream flowing axially in the passage traverses the spaces of the wheel axially;
screen inserts braced axially against the wheel at the spaces between the spokes and angularly movable with the wheel with the melt flowing through the screen inserts when aligned with the passage;
a piston/cylinder unit actuatable to push melt axially through the wheel at a location offset angularly from the passage to backflush or prefill a one of the screen inserts at the location;
a lever pivoted on the housing:
a double-acting cylinder connected between the housing and the lever for pivotally reciprocating the lever;
a one-way connection between the lever and the wheel for rotating the wheel on pivoting of the lever on one direction and for slipping on pivoting of the lever in an opposite direction; and
a releasable coupling between the lever and the piston/cylinder unit having a coupled position in which pivoting of the lever is transmitted to the piston/cylinder unit for backflushing or prefilling and a decoupled position in which the piston/cylinder unit is stationary when the lever is pivoted by the drive.
